(19) United States
(12) Patent Application Publication
(10) Pub. No.: US 2008/0181483 A1
(43) Pub. Date: Jul. 31, 2008

(54) Scintillation evaluation method and device thereof

(75) Inventor: Hideya Seki, Okaya-shi (JP)

Correspondence Address: OLIFF & BERRIDGE, PLC, P.O. BOX 320850, ALEXANDRIA, VA, 22320-4850, US

(73) Assignee: SEIKO EPSON CORPORATION, TOKYO (JP)

(21) Appl. No.: 12/007,566

(22) Filed: Jan. 11, 2008

(30) Foreign Application Priority Data
Jan. 15, 2007 (JP) 2007-005904

(51) Int. Cl. G06K 9/00

(52) U.S. Cl. 382/141

(57) ABSTRACT

A scintillation evaluation method for quantitatively evaluating scintillation, the method comprising: obtaining an image data that includes at least an interference pattern of scintillation; increasing the contrast of the interference pattern; and determining the amount of variation of brightness in the image data, the amount of the variation corresponding to the interference pattern whose contrast has been increased.

### CROSS-REFERENCE TO RELATED APPLICATION

This application is based on and claims priority from Japanese Patent Application No. 2007-005904, filed on Jan. 15, 2007, the contents of which are incorporated herein by reference.

### BACKGROUND

1. Technical Field

The present invention relates to a scintillation evaluation method and a device thereof, for evaluating scintillation which is intensely generated in various devices, particularly, a projector or the like using a laser light source therein.

2. Related Art

In recent years, projectors have come into wide use, including uses in presentation and movie projection.

The market for projectors is growing, particularly in their use as projection-type televisions.

Recently, projectors have increasingly used a Light Emitting Diode (LED) or a laser light source instead of a traditional lamp because the Light Emitting Diode or the laser light source has advantages in term of energy efficiency, color reproducibility, long life, quick lighting, or the like.

However, when displaying images with a projector, noise generated in the images is referred to as scintillation, speckle, or the like.

The scintillation can annoy a viewer because it may seem as if a veil exists between the screen surface and the viewer. Other than the annoyance that can be caused to viewers, the scintillation can also cause the viewer's eyes to become fatigued because the viewer must view a double image including both an image projected on the screen and the scintillation.

This is especially the case when a laser light source is used for the projector, since the laser light itself has high coherence, the scintillation that is generated can become unbearable for the viewer.

The scintillation is generated not only in projectors, but also in other display devices.

The reason scintillation is generated in other display devices, is that rough working (anti-glare processing or non-glare processing) is conventionally applied onto the surface of a display device in order to reduce the reflection of natural light. Therefore, similar to the dispersion structure on a projection screen, innumerable secondary wave sources are generated on the surface of the display device, and interference fringe is generated due to interference between the lights emitted from the secondary wave sources themselves.

That is, in a Cathode Ray Tube (CRT), a liquid crystal television, an uneven brightness Display (Plasma Display Panel, PDP), or the like, images having uneven brightness (unevenness or glaring) can be found by carefully observing the surface thereof.

Specifically, illumination with parallel light is used in a liquid crystal television similar to a projector. Therefore, though the scintillation generated in the liquid crystal television is not greater than the scintillation generated in the projector, the scintillation generated in the liquid crystal television is noticeable.

Therefore, a scintillation evaluation method and a scintillation evaluation device that could quantitatively compare and evaluate scintillation have been necessary for the evaluation of various display devices.

Specifically, a benchmark for determining the target level at which scintillation must be reduced has been required in the development of projection-type televisions.

However, quantitative evaluation for the above scintillation by a conventional method or device has been extremely difficult.

In conventional examples, as disclosed in Japanese Unexamined Patent Application, First Publication No. H10-293361, and Japanese Unexamined Patent Application, First Publication No. 2000-180973, for example, the scintillation is observed by visual examination, the presence or absence of scintillation is determined, and whether the display device (evaluation object) is good or bad is determined.

As described above, the simple organoleptic evaluation that evaluates whether a display device is good or bad by visual examination has been the conventional evaluation method with regard to scintillation.

That is, the conventional methods are not methods in which it is possible to objectively and quantitatively comprehend the degree of scintillation generation.

There are problems in that the evaluation results can vary if the evaluation object is evaluated several times by different experimenters, and it is impossible to obtain reproducible evaluation results when evaluations are performed by different experimenters. Therefore, it is difficult to perform the comparison of the performances of various display devices in regards to scintillation, the evaluation of scintillation reduction techniques, and the like.

The necessity of using the organoleptic evaluation method described above may be sufficiently understood by a person of ordinary skill in this technical field. Since the fact is well-known that the scintillation is an interference phenomenon occurring in the viewer's inner eyes. The intensity of the scintillation is also variable depending on the characteristics of the viewer's eyes and the eyesight of the viewer.

The user's feelings and reactions to the scintillation vary depending on a number of factors, including user disposition (e.g., neuroticism, carelessness, anxiety, or the like) and fatigue, the brightness of the screen and the like.

Therefore, objectively quantifying scintillation has been impossible.

Thus, as the conventional evaluation method with regard to scintillation, the simple method described above or an organoleptic evaluation method such as a Psychophysic measuring method must be used, even if the evaluation method is contrived.

As described above, since the conventional method for evaluating scintillation is the organoleptic evaluation method, it is impossible to comprehensively determine whether a projection-type television is superior or inferior. For example, it is impossible to determine which projection-type television is superior among the manufacturers thereof, which type of display is superior among different types, and the like.

### SUMMARY

An advantage of some aspects of the invention is to provide a scintillation evaluation method and a scintillation evaluation device, in which it is possible to quantitatively and objectively evaluate the degree of scintillation and to sufficiently evaluate and contrast the scintillation of different devices.

The inventor has diligently researched and considered the conventional scintillation evaluation method, and found that there are three problems as described below.

The inventor has also determined that it is possible to perform an evaluation which corresponds with human visual appreciation with as high a level of precision as with the conventional evaluation method, by improving performance in at least one of the three problems.

These three problems will be explained below.

First Problem (with Regard to Detection Sensitivity)

Though the explanation is omitted in the above description, quantification of scintillation (speckle) has been attempted using the conventional methods.

An exclusive well-known method is the method including: providing the camera adjusted so as to match the F-number (focal ratio) of a human's eyes (5.6) and the afterimage time of a human's eyes ( 1/30 second); image capturing a screen by using the camera in a defocussed state; determining the speckle contrast value from the picture; and evaluating the scintillation based on the speckle contrast value.

The speckle contrast value is determined based on a histogram. The histogram is expressed based on the occurrence frequency of the gradation value in the image data including the interference pattern.

This method has an advantage when samples having a conspicuous difference with regard to the degree of scintillation are evaluated. For example, when the image formed by a laser projector, which generates conspicuous scintillation in the image, and the image formed by a lamp light source projector are compared.

However, in this method, it is difficult to detect slight differences, between a lamp light source projector, a liquid crystal television, a CRT, a PDP, and the like.

Also, when visually comparing the projector in which the scintillation generation is prevented and the projector in which scintillation is generated, though the prevention effects of scintillation can be understood, it is difficult to quantify the effects.

Therefore, in the conventional method, the sensitivity of detection of scintillation is low, and the difference of the speckle contrast values is low and variable. Furthermore, the determination based on measurement values, often inversely correlates to the values based on human visual appreciation.

Second Problem (with Regard to Pixel Grid Noise)

Liquid crystal televisions, CRTs, and PDPs are spatial-color-synthesis-type display devices. Therefore, a single color constitutes pixels of three colors in a specific pattern such as a stripe.

Specifically, when the image displayed on the CRT is image captured, clear pixel grids are generated on the image due to the shadow mask or aperture grille.

Also, in projection-type televisions, grids, including cell structure, are generated on the image due to pixel division by the light valve thereof.

By determining the speckle contrast value, in the above-described evaluation, the above-described histogram is presupposed as the normal distribution, and the irregularities are compared.

However, if the image includes the component of the above-described pixel grid, the noise is generated, and the gradation distribution of the pixel does not coincide with the normal distribution.

In this case, the speckle contrast value which is calculated based on the histogram is an imprecise value. This causes an inversion phenomenon in that the numerical evaluation can sometimes be the inverse of the visual appreciation evaluation.

Third Problem (with Regard to the Condition of the Viewer's Eyes)

When the dispersion layer of the screen includes an uneven surface, a random pattern is generated based on an interference fringe due to scintillation (speckle).

That is, the pattern of the interference fringe is evenly distributed on the entire screen.

For example, the formation of a histogram based on a simple random pattern is in a white noise form, and flat.

However, in the above-described histogram, when a moving average is calculated based on a region of the histogram, normal distribution occurs.

On the other hand, since spatial definition of the human eyes is determinate, an the effects of equalization similar to the above instance occurs.

Thus, there are no studies that show it is impossible to quantitatively and essentially evaluate the scintillation.

However, in conventional methods, scintillation has been evaluated based only on the variation of pixel gradation of interference fringe. Therefore, the condition relative to a spatial axis direction has not been considered.

This causes the numerical evaluation to not coincide with the visual appreciation evaluation.

A first aspect of the invention provides a scintillation evaluation method for quantitatively evaluating scintillation. The method includes: obtaining an image data that includes at least an interference pattern of scintillation; increasing the contrast of the interference pattern; and determining the amount of variation of brightness in the image data, the amount of the variation corresponding to the interference pattern whose contrast has been increased.

It is preferable that, in the method of the first aspect of the invention, the determining of the amount of variation of brightness include: creating a histogram based on the image data corresponding to the interference pattern whose contrast has been increased, the histogram expressing the occurrence frequency of pixels of the image data at each of the gradation values; and determining the amount of variation of brightness by determining a speckle contrast value based on the histogram.

Since the scintillation evaluation method of the first aspect the invention includes increasing the contrast of the interference pattern, it is possible to improve the degree of detection sensitivity. Therefore, it is possible to solve the problem using conventional methods, in which the degree of detection sensitivity is low.

As a result, when of comparing various display devices with regard to the performance thereof, the difference in the speckle contrast values, increases, and it is possible to obtain evaluation result which coincides with human visual appreciation.

It is preferable that, in the method of the first aspect of the invention, obtaining the image data include: image capturing the scintillation by using a pinhole camera; and capturing the image data including the interference pattern by image capturing the scintillation where the contrast of the interference pattern has been increased.

In this manner, when capturing an interference pattern of scintillation, incident light is limited by the pinhole. Therefore, the effects of equalization are restricted, and the amount of the component is offset is decreased. As a result, it is possible to increase the contrast.

In the case of using the pinhole camera, it is possible to easily obtain the effects as further described below in detail.

It is preferable that the method of the first aspect of the invention further include removing a noise component corresponding to a pixel grid from the image data that includes the interference pattern.

In this manner, the noise component corresponding to the pixel grid is removed. Thereby, the histogram of the gradation value is closer to the normal distribution and it is possible to precisely determine the speckle contrast value based on the histogram.

As a result, it is possible to obtain an evaluation result which coincides with human visual appreciation.

It is preferable that, in the method of the first aspect of the invention, the noise component be removed by a spatial frequency filtering process using Fourier transform.

In this manner, it is extremely easy to remove the noise component by using image processing software.

It is preferable that the method of the first aspect of the invention further include decreasing the definition of the image data that includes the interference pattern.

In this manner, the histogram created based on definition, which has not been decreased is converted into the histogram where the spatial definition of the human eyes is considered. Thereby, the speckle contrast value is determined based on the converted histogram and it is possible to perform the evaluation based on the speckle contrast value that corresponds with the human visual appreciation evaluation.

It is preferable that, in the method of the first aspect of the invention, the definition be decreased by an equalizing process using a moving average filter.

In this manner, it is extremely easy to decrease the definition by using image processing software.

A second aspect of the invention provides a scintillation evaluation method for quantitatively evaluating scintillation. The method includes: obtaining an image data that includes at least an interference pattern of scintillation; removing a noise component corresponding to a pixel grid from the image data; and determining the amount of variation of brightness in the image data, the amount of the variation corresponding to the interference pattern whose noise component has been removed.

It is preferable that, in the method of the second aspect of the invention, determining the amount of variation of brightness include: creating a histogram based on the image data corresponding to the interference pattern whose noise component has been removed, the histogram expressing the occurrence frequency of pixels of the image data at each of the gradation values; and determining the amount of variation of brightness by determining a speckle contrast value based on the histogram.

According to the scintillation evaluation method of the second aspect of the invention, the noise component corresponding to the pixel grid is removed. Thereby, the histogram of gradation value is closer to the normal distribution, and it is possible to precisely determine the speckle contrast value based on the histogram.

As a result, it is possible to obtain an evaluation result which coincides with human visual appreciation.

It is preferable that, in the method of the second aspect of the invention, the noise component be removed by a spatial frequency filtering process using a Fourier transform.

In this manner, it is extremely easy to remove the noise component by using image processing software.

A third aspect of the invention provides a scintillation evaluation method for quantitatively evaluating scintillation. The method includes: obtaining an image data that includes at least an interference pattern of scintillation; decreasing the definition of the image data; and determining the amount of variation of brightness in the image data, the amount of variation corresponding to the interference pattern whose definition has been decreased.

It is preferable that, in the method of the third aspect of the invention, the determining of the amount of variation of brightness include: creating a histogram based on the image data corresponding to the interference pattern whose definition has been decreased, the histogram expressing the occurrence frequency of pixels of the image data at each of the gradation values; and determining the amount of variation of brightness by determining a speckle contrast value based on the histogram.

According to the scintillation evaluation method of the third aspect of the invention, the histogram created based on definition which has not been decreased is converted into a histogram where the spatial definition of the human eyes is considered. Thereby, the speckle contrast value is determined based on the converted histogram, and it is possible to perform the evaluation based on the speckle contrast value that corresponds with the human visual appreciation evaluation.

It is preferable that, in the method of the third aspect of the invention, the definition be decreased by an equalizing process using a moving average filter.

In this manner, it is extremely easy to decrease the definition by using image processing software.

A fourth aspect of the invention provides a scintillation evaluation device for quantitatively evaluating scintillation. The device includes: a pinhole camera obtaining an image data that includes an interference pattern of scintillation; an image processing section executing an image processing in which a noise component corresponding to a pixel grid is removed from the image data, and in which the definition of the image data is decreased; and an operation section determining the amount of variation of brightness in the image data, the amount of the variation corresponding to the interference pattern whose noise component has been removed and whose definition has been decreased.

It is preferable that, in the method of the fourth aspect of the invention, the operation section determine a histogram based on the image data corresponding to the interference pattern whose noise component has been removed and whose definition has been decreased, the histogram expressing the occurrence frequency of pixels of the image data at each of the gradation values, and the operation section determine the amount of variation of brightness by determining a speckle contrast value based on the histogram.

According to the scintillation evaluation device of the fourth aspect of the invention, by image capturing the scintillation by using a pinhole camera, it is possible to capture the image data where the contrast of the interference pattern has been increased.

After the capture of the image data, the removal of the noise component and the decrease of the definition of the image data are completed by the image processing section, a histogram expressed by the occurrence frequency of pixels of the image data at each of the gradation values is created. After the creation of the histogram, the operation section determines the amount of variation of brightness by determining a speckle contrast value based on the histogram.

Therefore, the speckle contrast value which is obtained by the scintillation evaluation device is further coincided with human visual appreciation.

### BRIEF DESCRIPTION OF THE DRAWINGS

FIG. 1 is a view explaining the generation of scintillation.

FIG. 2 is a schematic view showing the constitution of an entire evaluation system including a scintillation evaluation device of the first embodiment of the invention.

FIG. 3 is a view explaining the operations and effects of a pinhole camera of the scintillation evaluation device.

FIG. 4 is a view explaining the concept of the process of removing pixel grid noise.

FIG. 5 is a view showing an original image of a liquid crystal television which was image captured at a close distance (100 mm).

FIG. 6 is a view showing an image transformed from the original image of FIG. 5 by Fourier transform.

FIG. 7 is a view showing the image in which pixel grid noise has been eliminated from the Fourier-transformed image.

FIG. 8 is a view showing the image transformed by an Inverse-Fourier transform from the image in which the pixel grid noise has been eliminated.

FIG. 9 is a view showing an original image of a plasma television which was image captured at a close distance (100 mm).

FIG. 10 is a view showing an image transformed from the original image of FIG. 9 by Fourier transform.

FIG. 11 is a view showing the image in which pixel grid noise has been eliminated from the Fourier-transformed image.

FIG. 12 is a view showing the image transformed by an Inverse-Fourier transform from the image in which the pixel grid noise has been eliminated.

FIG. 13 is a view showing an original image of a rear projection-type projector which was image captured at a close distance (100 mm).

FIG. 14 is a view showing an image transformed from the original image of FIG. 13 by Fourier transform.

FIG. 15 is a view showing the image in which pixel grid noise has been eliminated from the Fourier-transformed image.

FIG. 16 is a view showing the image transformed by an Inverse-Fourier transform from the image in which the pixel grid noise has been eliminated.

FIG. 17 is a view showing an original image of a rear projection-type projector which was image captured at a close distance (0 mm).

FIG. 18 is a view showing an image transformed from the original image of FIG. 17 by Fourier transform.

FIG. 19 is a view showing the image in which pixel grid noise has been eliminated from the Fourier-transformed image.

FIG. 20 is a view showing the image transformed by an Inverse-Fourier transform from the image in which the pixel grid noise has been eliminated.

FIGS. 21A and 21B are views explaining the concept of a definition decreasing process.

FIG. 22 is a schematic view showing a scintillation evaluation device of the second embodiment of the invention.

FIG. 23 is a schematic view showing a scintillation evaluation device of the third embodiment of the invention.

FIG. 24 is a schematic view showing a scintillation evaluation device of the fourth embodiment of the invention.

FIG. 25 is a schematic view showing a scintillation evaluation device of the fifth embodiment of the invention.

FIG. 26 is a schematic view showing a scintillation evaluation device of the sixth embodiment of the invention.

### DESCRIPTION OF EXEMPLARY EMBODIMENTS

### First Embodiment

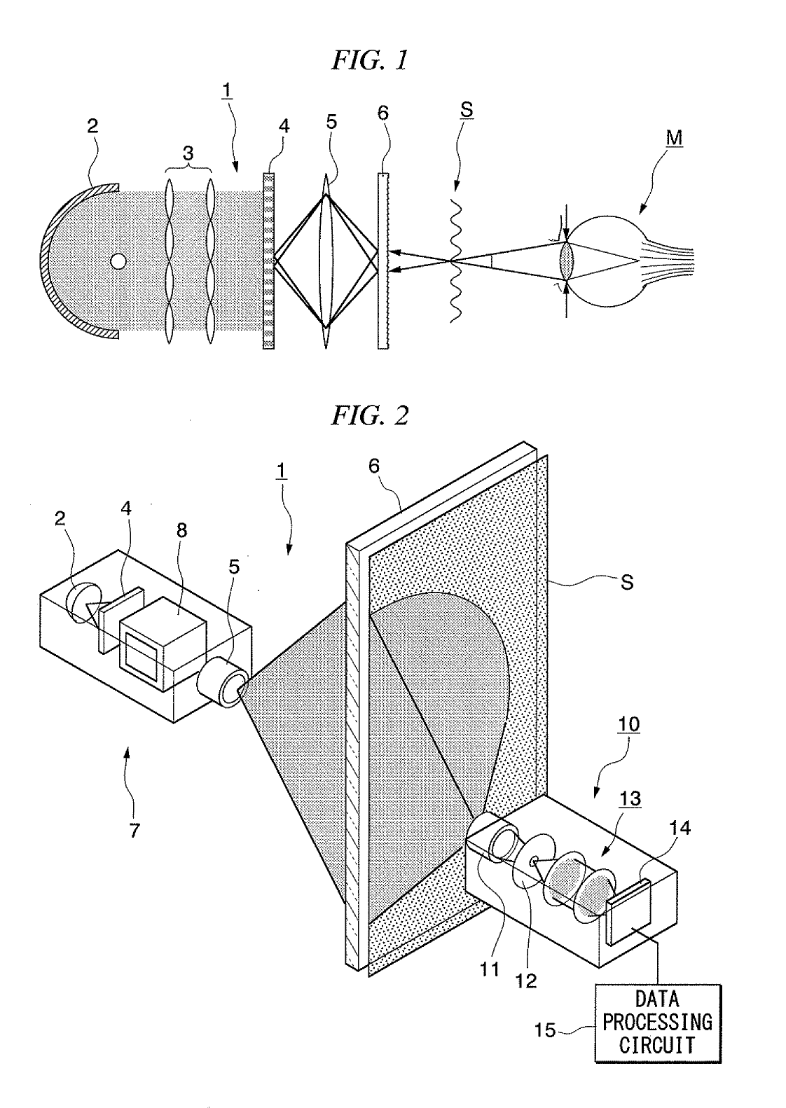

Hereinafter, a first embodiment of the invention will be described with reference to FIGS. 1 to 21B.

In the first embodiment, for example, an evaluation method for evaluating scintillation generated in a rear projection-type projector is explained.

FIG. 1 is a view explaining the generation of scintillation.

FIG. 2 is a schematic view showing the constitution of an entire evaluation system including a scintillation evaluation device of the first embodiment of the invention.

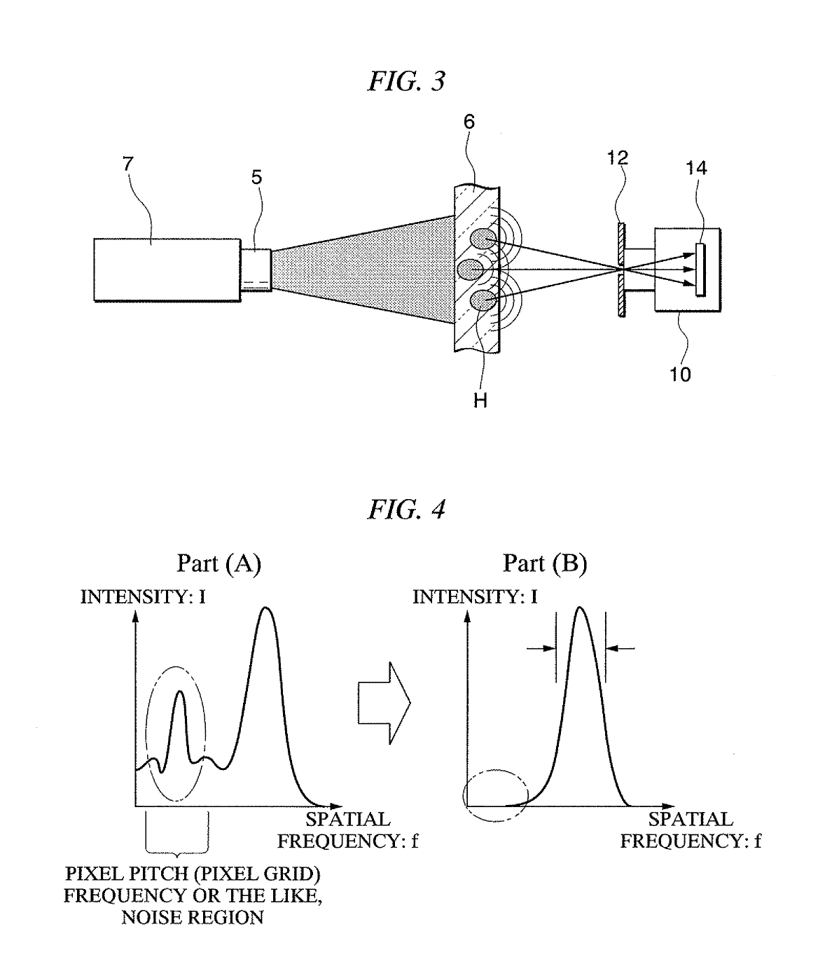

FIG. 3 is a view explaining the operations and effects of a pinhole camera of the scintillation evaluation device.

FIG. 4 is a view explaining the concept of the process of removing pixel grid noise.

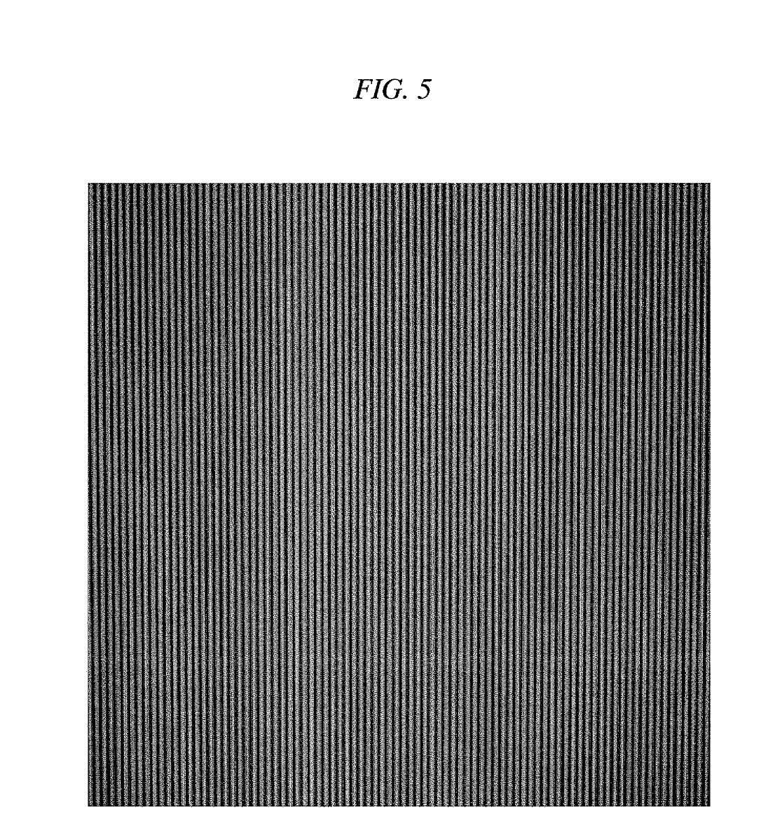

FIGS. 5 to 20 are views showing the images, each of which is captured in a state of the image processing of the removing process.

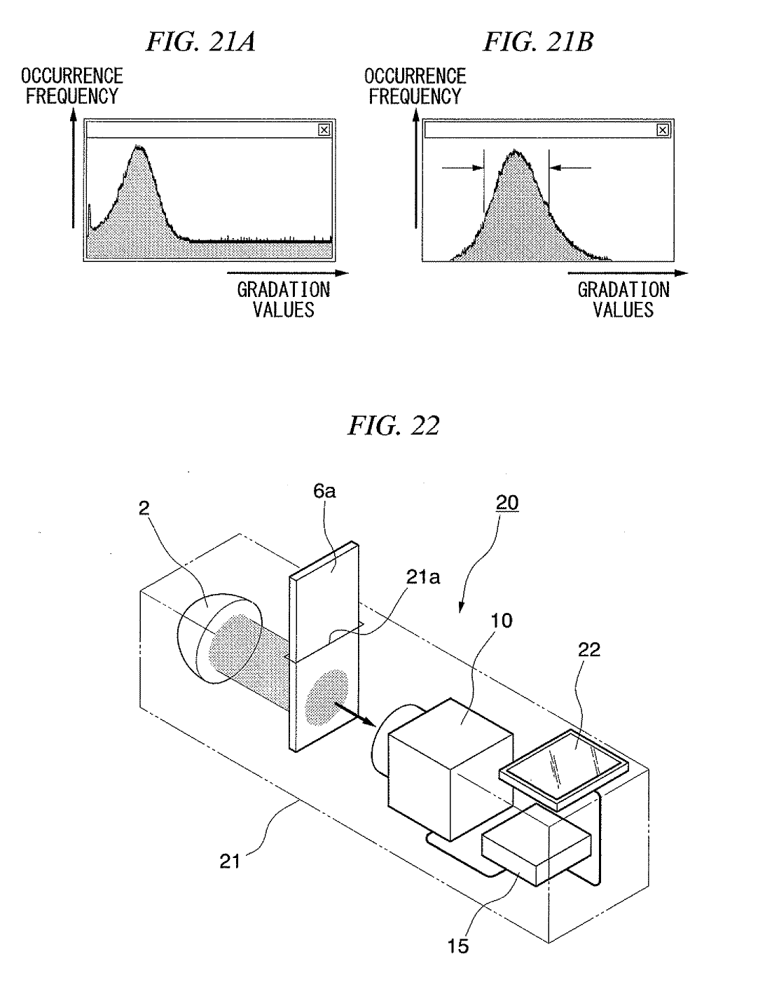

FIGS. 21A and 21B are views explaining the concept of a definition decreasing process.

In the drawings described below, the proportion of film thicknesses dimensions and the like of the respective component elements have been suitably altered in order to make the drawings easier to comprehend.

As shown in FIG. 1, a rear projection-type projector 1 includes a light source 2, a fly-eye integrator 3, a liquid crystal light valve 4, a projection lens 5, and a screen 6.

In the rear projection-type projector 1, the light source 2 emits light, and the illumination of the light that has been emitted from the light source 2 is uniformed by the fly-eye integrator 3. After the light has been uniformed, the light is modulated in the liquid crystal light valve 4, and the modulated light is projected onto the screen 6 by passing through the projection lens 5.

In this manner, the image formed by the modulated light is projected onto the screen 6, and a viewer M can see the image.

The screen 6 has a dispersion structure for forming the images. In the microscopic view of the dispersion structure, the dispersion structure is the aggregate structure of secondary wave sources. The lights emitted from the secondary wave sources interfere with each other, thereby interference pattern S (interference fringe) is generated at a position which is slightly separated form the screen 6.

This interference fringe is scintillation (speckle) that is the evaluation object of the evaluation method and the scintillation evaluation device of the invention.

As shown in FIG. 2, the entire evaluation system the first embodiment includes the rear projection-type projector 1 including a projection engine 7, the screen 6, and a pinhole camera 10.

The projection engine 7 includes the light source 2, the liquid crystal light valve 4, a color synthesis prism 8, the projection lens 5, or the like. The light source 2, the liquid crystal light valve 4, and the projection lens 5 are described above.

In addition, the pinhole camera 10 includes an objective lens 11, a pinhole 12, a relay lens 13, a capturing element 14 constituted by a CCD or the like.

The image formed on the screen 6 and pattern of the scintillation are image captured by the pinhole camera 10. Especially, the image and the pattern are captured by the capturing element 14 in the pinhole camera 10.

Furthermore, a data processing circuit 15, including an image processing section and an operation section, is connected to the capturing element 14. The data processing circuit 15 performs image processing as described below and determines a speckle contrast value based on the image data obtained by the capturing element 14.

The scintillation evaluation method of the first embodiment includes: a obtaining step for image capturing the image data which includes scintillation and which is displayed onto the screen 6 by using the pinhole camera 10, and capturing the image including an interference pattern in the state of increasing the contrast of the interference pattern of scintillation; a removing step for removing a noise component corresponding to a pixel grid from the image data that includes the interference pattern; a decreasing step for decreasing the definition of the image data that includes the interference pattern; a creating step for creating a histogram based on the image data corresponding to the interference pattern and the histogram expressing the occurrence frequency of pixels of the image data at each of the gradation values; and a determining step for determining a speckle contrast value based on the histogram. These steps are performed in sequence as described above.

Furthermore, in the removing step, a spatial frequency filtering process is performed by using a Fourier transform.

Furthermore, in the decreasing step, an equalizing process is performed by using a moving average filter.

As a first step, the image displayed on the screen 6 is image captured by using the pinhole camera 10. The image includes an interference pattern of scintillation S.

As described below, the inventor has two considerations as to why the contrast of the interference pattern increases in the case of image capturing the image by using the pinhole camera.

First Consideration (with Regard to Selective Interference)

When there are a lot of secondary wave sources affecting the interference on the screen, the light beams which surpass a coherence length and which overlap each other are not re-interfered with they add to each other. Thereby, the light beams are equalized and evened out. Thus, in this case, the contrast of the interference pattern (interference fringe) is decreased.

In contrast, as shown in FIG. 3, when using the pinhole 12 of the pinhole camera 10, the light passed through the pinhole 12 is the restricted light by the pinhole 12 from the lights emitted from the secondary wave sources H of screen 6. Thus, the restricted light by the pinhole 12 is extracted. Thereby, the light is image captured by the capturing element 14. In this case, since the interference pattern formed by the light has not been equalized, the contrast of the interference pattern becomes significant.

As a result, it is possible to observe a clean interference pattern.

Second Consideration 2 (with Regard to Separation of Illuminant Image)

In capturing the dispersion of light, the light beam component which is light directly emitted from the light source, is offset, thereby decreasing the contrast (light and shade) of the dispersion light.

In this phenomenon, the same principle occurs as that when the contrast of a display device decreases in a lightroom.

Therefore, there are optical systems in which the dispersion light is only extracted by separating the dispersion light and the light source light, and by utilizing the different properties of the light beams.

In the constitution of the first embodiment, the dispersion light can pass through the pinhole at every angle. However, the amount of parallel light which forms the illuminant image and which passes through the pinhole is limited.

Therefore, the dispersion light is selectively directed to the capturing element 14.

As described above, since the offset component of the light source is decreased, it is possible to observe the interference pattern with high contrast.

As a second step, by performing the spatial frequency filtering process using a Fourier transform, the noise component corresponding to the pixel grid is removed from the image data. The image data includes the interference pattern.

Specifically, as shown in Part (A) of FIG. 4, the interference pattern is transferred to the coordinate system with the spatial frequency axis as the axis of abscissas and the Intensity axis as the axis of the axis of ordinates. In this coordinate system, the spatial frequency component which is a noise component corresponding to the pixel grid whose spatial frequency, is comparatively low, is found. The spatial frequency component is indicated by dashed and two-dotted lines in Part (A) of FIG. 4. The spatial frequency component includes pixel pitch frequency, or the like. The spatial frequency component is indicated as the noise region in Part (A) of FIG. 4. Furthermore, as shown in Part (B) of FIG. 4, the spatial frequency component (noise component) is removed by performing the spatial frequency filtering process.

These sequential processes can be easily performed by using image processing software.

By removing the noise component corresponding to the pixel grid, the histogram of the gradation value is closer to the normal distribution as shown in FIG. 4.

FIGS. 5 to 20 are views showing illustrations of the pictures and showing the actual images captured in every steps of the image process.

FIG. 5 is a view showing an original image of a liquid crystal television which was image captured at a close distance (100 mm).

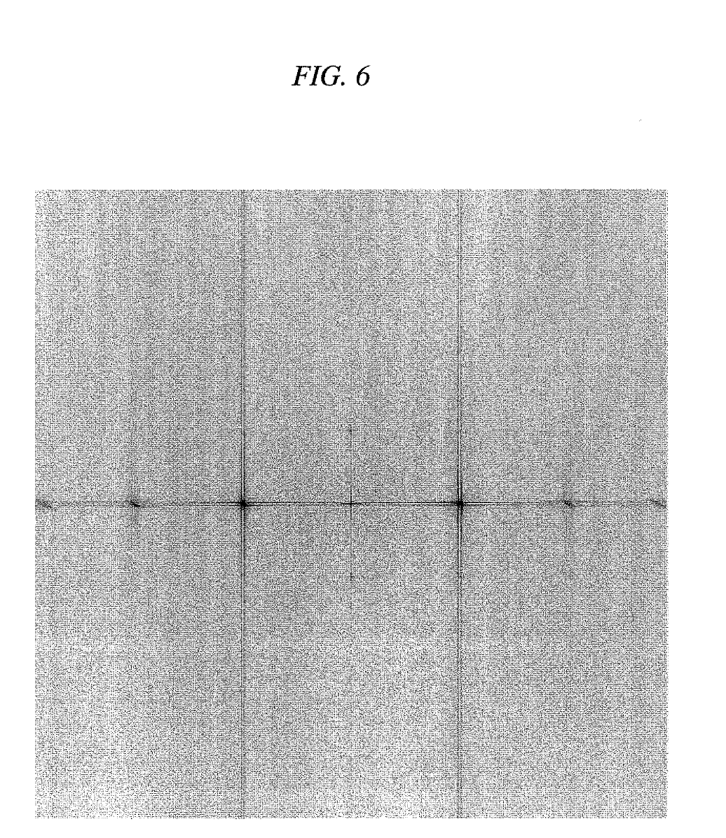

FIG. 6 is a view showing an image transformed from the original image of FIG. 5 by Fourier transform.

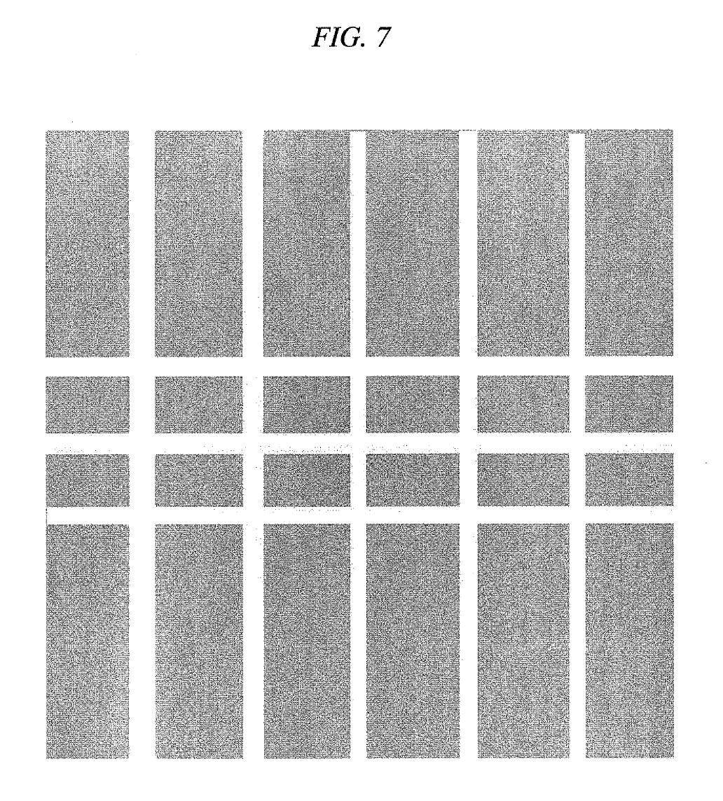

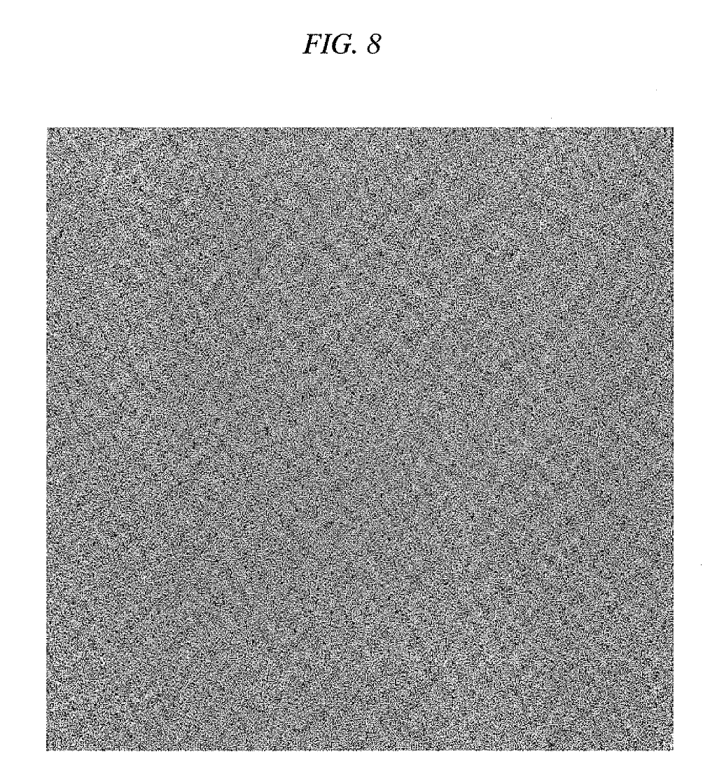

FIG. 7 is a view showing the image in which pixel grid noise has been eliminated from the Fourier-transformed image.

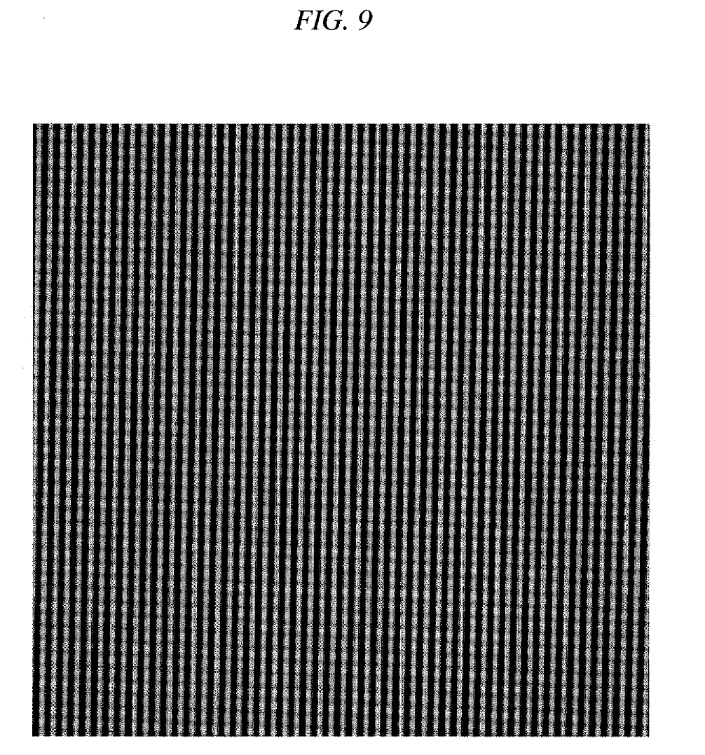

FIG. 8 is a view showing the image transformed by an Inverse-Fourier transform from the image in which the pixel grid noise has been eliminated.

FIG. 9 is a view showing an original image of a plasma television which was image captured at a close distance (100 mm).

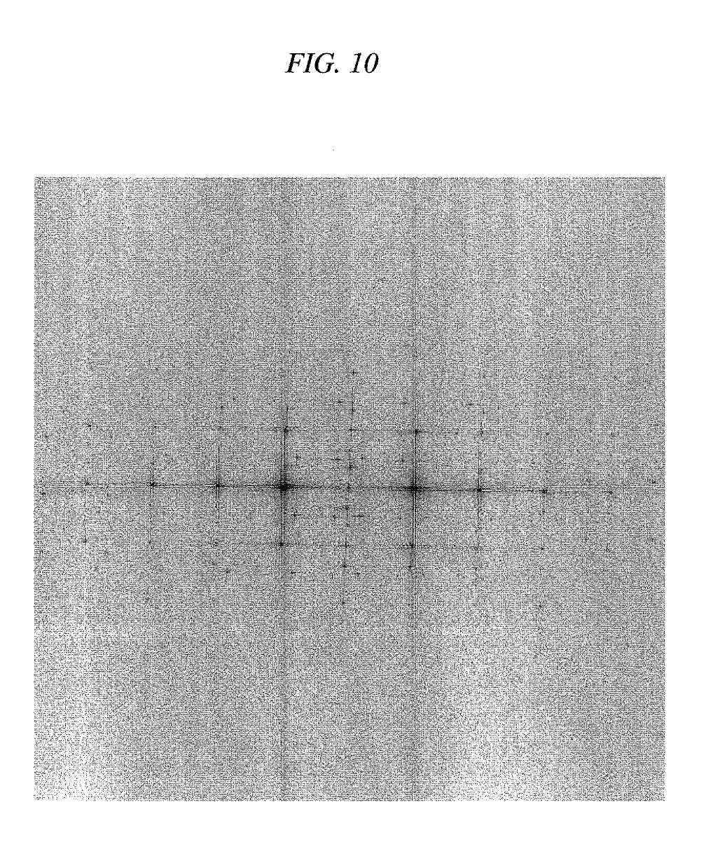

FIG. 10 is a view showing an image transformed from the original image of FIG. 9 by Fourier transform.

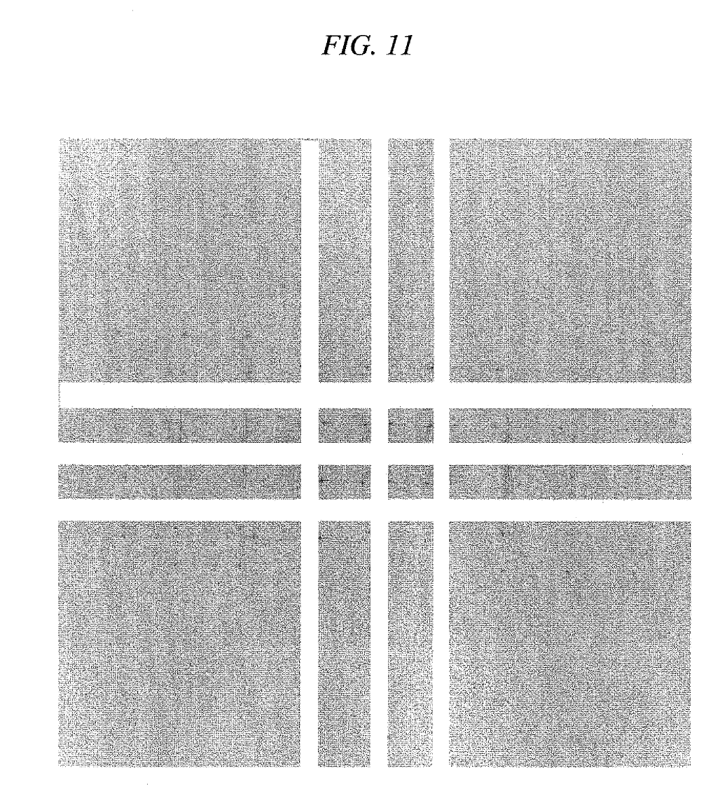

FIG. 11 is a view showing the image in which pixel grid noise has been eliminated from the Fourier-transformed image.

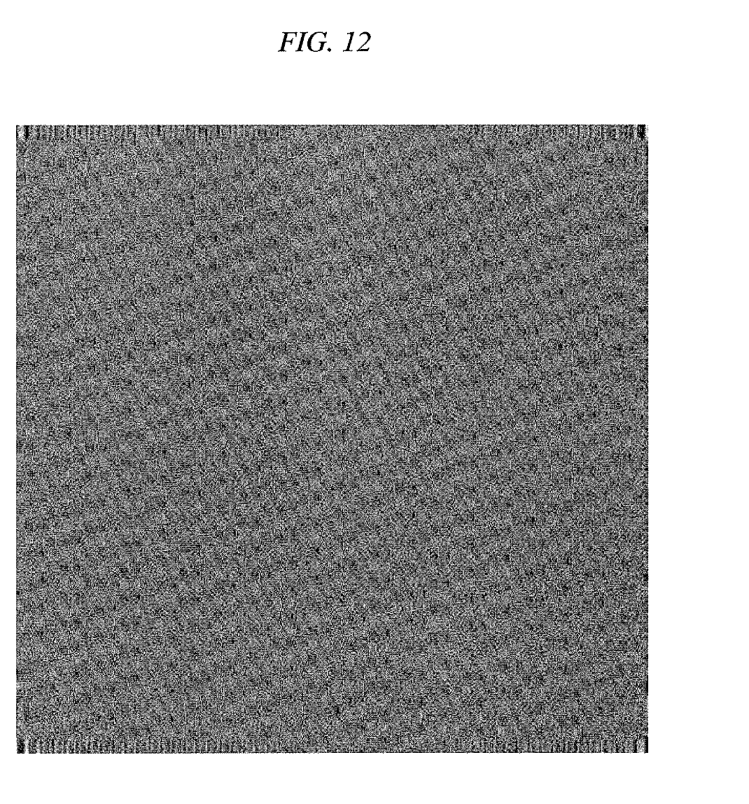

FIG. 12 is a view showing the image transformed by an Inverse-Fourier transform from the image in which the pixel grid noise has been eliminated.

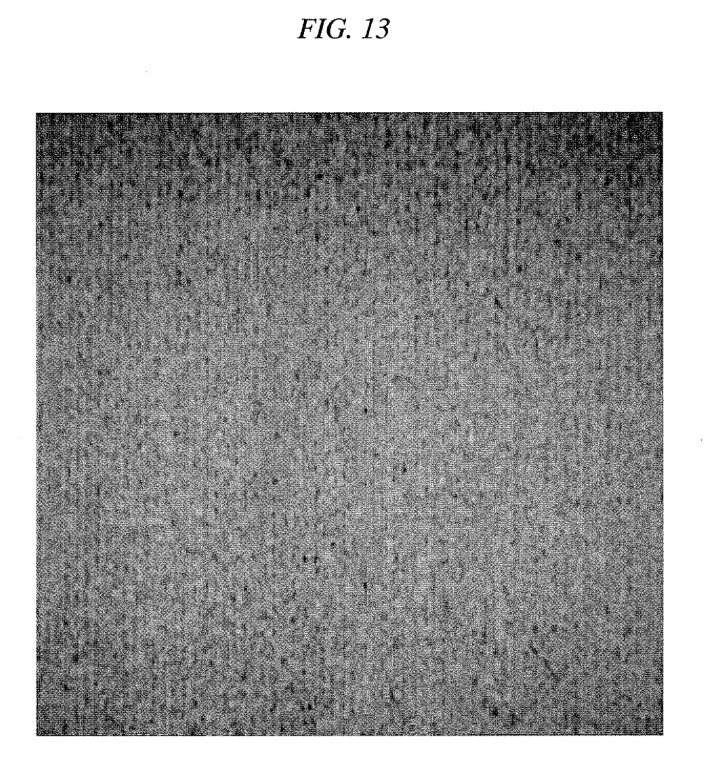

FIG. 13 is a view showing an original image of a rear projection-type projector which was image captured at a close distance (100 mm).

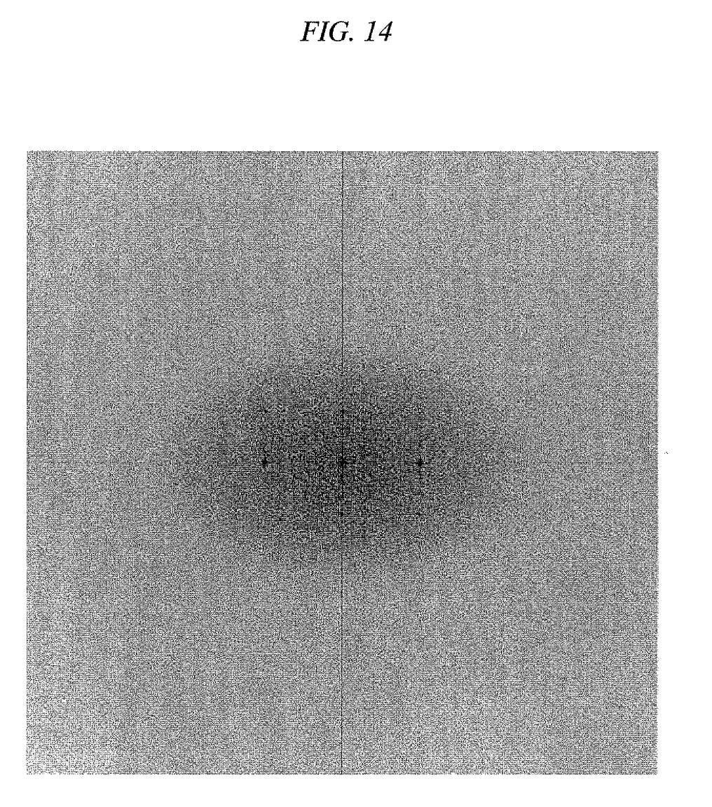

FIG. 14 is a view showing an image transformed from the original image of FIG. 13 by Fourier transform.

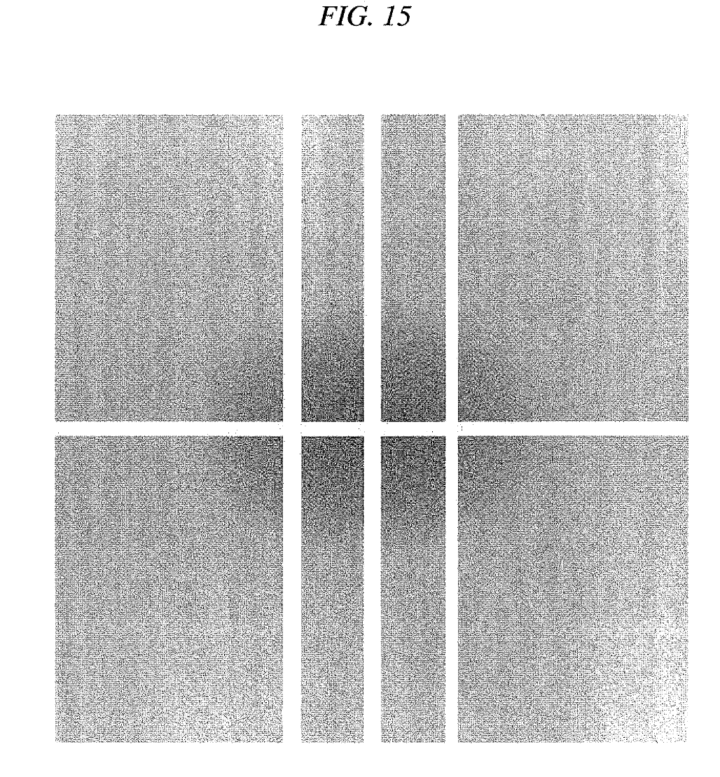

FIG. 15 is a view showing the image in which pixel grid noise has been eliminated from the Fourier-transformed image.

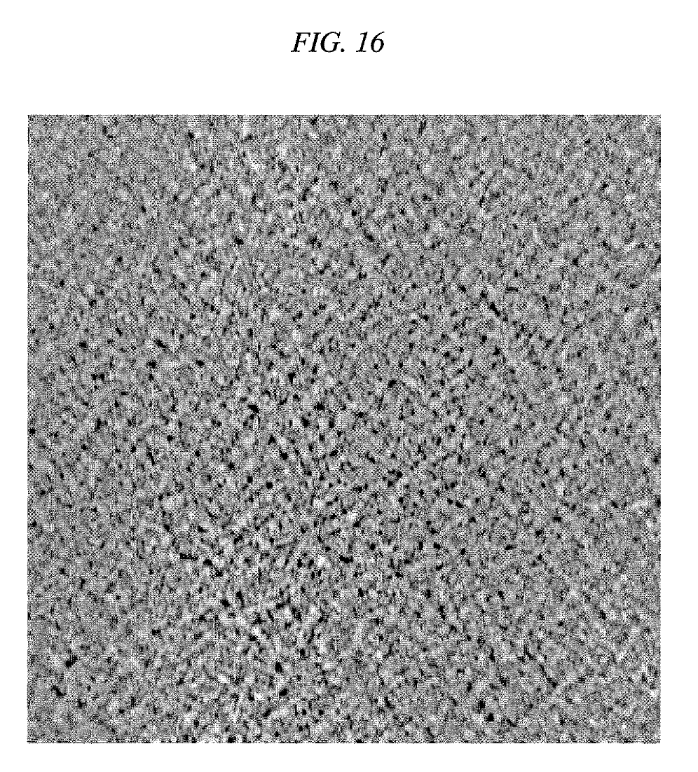

FIG. 16 is a view showing the image transformed by an Inverse-Fourier transform from the image in which the pixel grid noise has been eliminated.

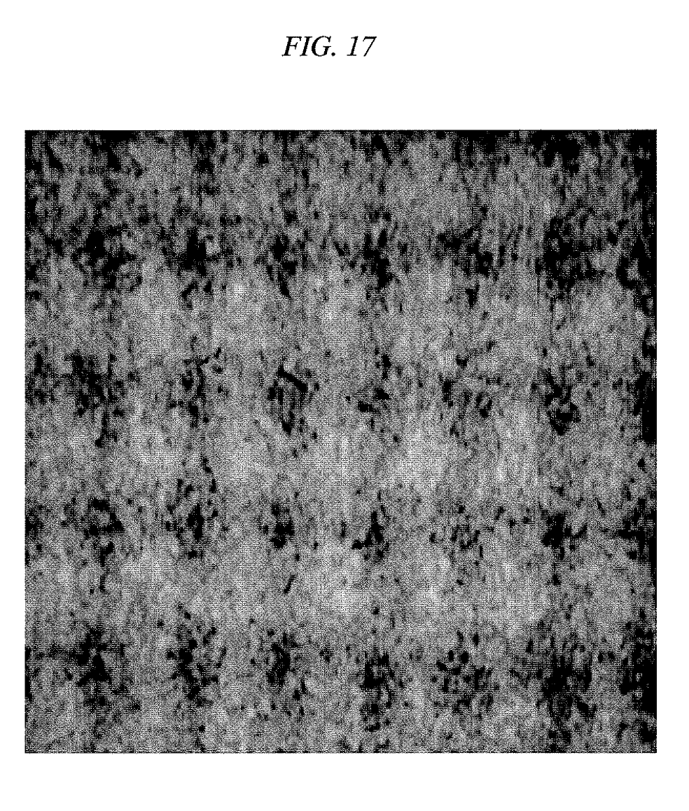

FIG. 17 is a view showing an original image of a rear projection-type projector which was image captured at a close distance (0 mm).

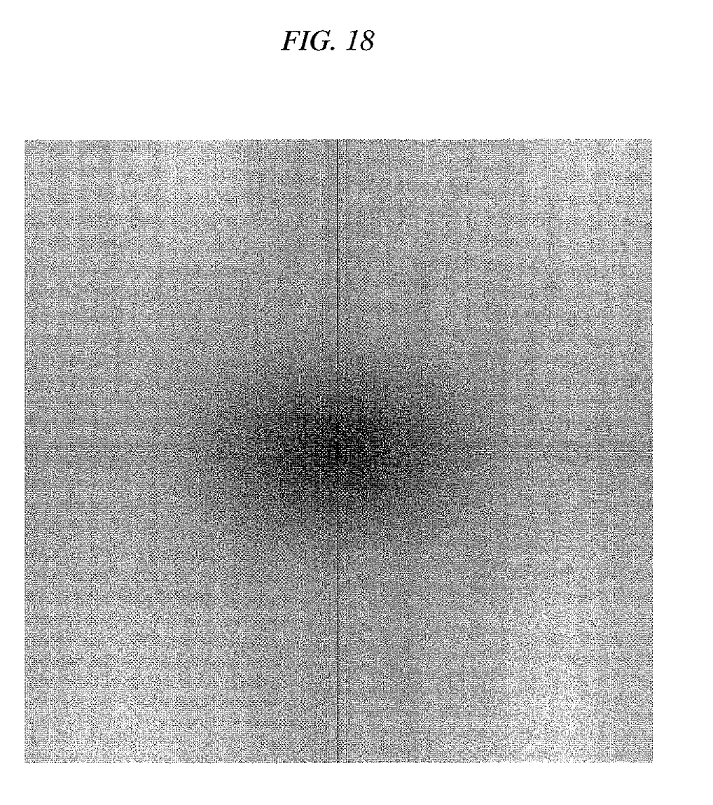

FIG. 18 is a view showing an image transformed from the original image of FIG. 17 by Fourier transform.

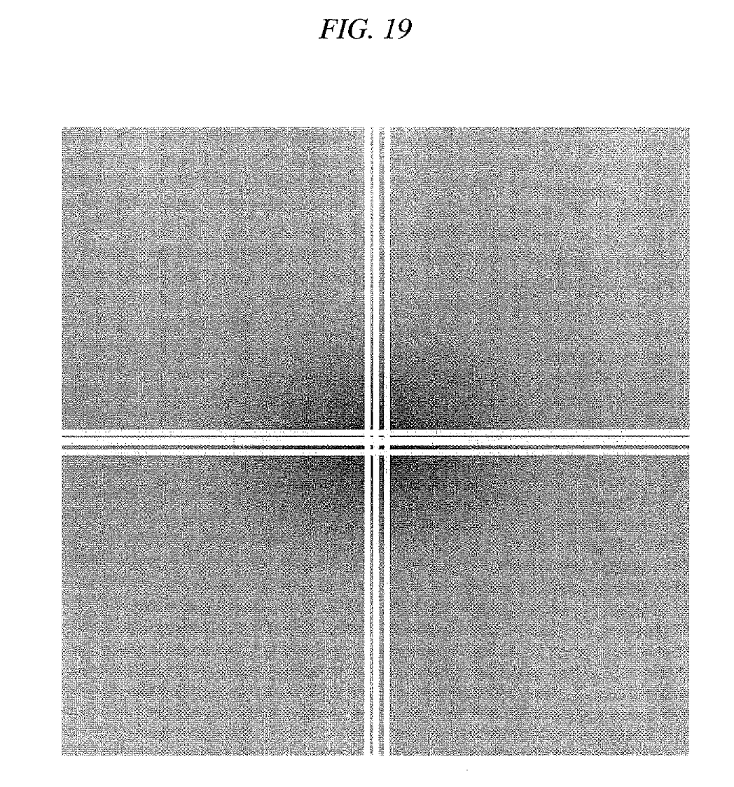

FIG. 19 is a view showing the image in which pixel grid noise has been eliminated from the Fourier-transformed image.

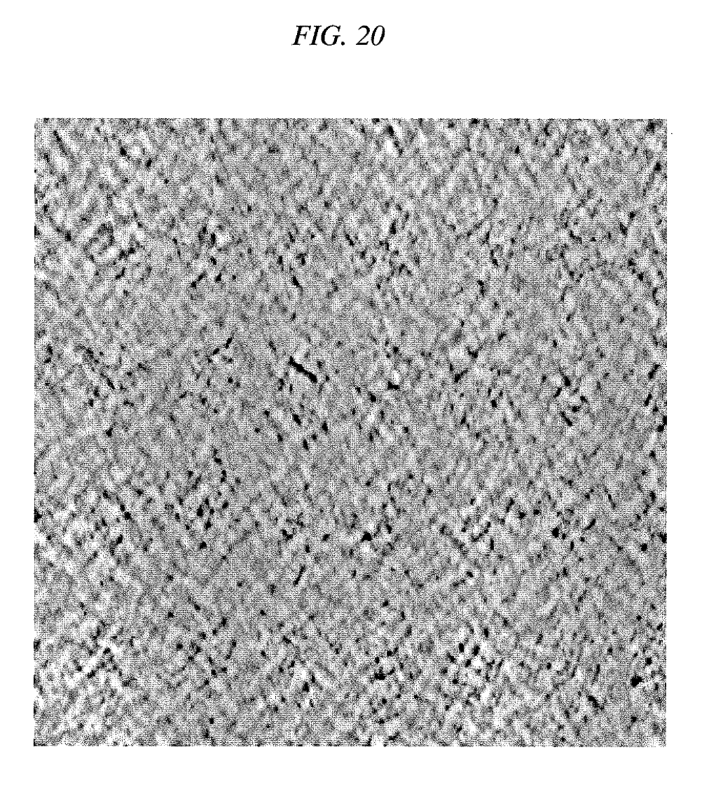

FIG. 20 is a view showing the image transformed by an Inverse-Fourier transform from the image in which the pixel grid noise has been eliminated.

FIGS. 8, 12, 16, and 20 are views indicating final image process results. As clearly shown in FIGS. 8, 12, 16, and 20, by removing the noise component of the pixel grid, the interference pattern of scintillation, which is almost never observable in the original image, can be distinctly observed.

Furthermore, the difference in scintillation can be distinctly observed between various display devices such as a liquid crystal television, a plasma television, a rear projection-type projector, and the like.

As a third step, by performing the equalizing process using a moving average filter, the definition of the image data including the interference pattern is decreased.

In the image processing, the definition is decreased from the images, as shown in FIGS. 8, 12, 16, and 20, where the pixel grid noise has been removed.

FIG. 21A shows the histogram created based on the image which was captured by a pinhole camera having, for example, 4288×2848 pixels. FIG. 21B shows the histogram created based on the image which is captured by pinhole camera having, for example, 800×600 of pixels less than that of FIG. 21A.

Here, the histogram shown in FIGS. 21A and 21B, the axis of abscissas represents gradation values and the axis of ordinates represents occurrence frequency. Therefore, the histogram shown in FIG. 21A shows how many pixels among the 4288×2848 pixels are distributed at each of the gradation values. Also, the histogram shown in FIG. 21B shows how many pixels among the 800×600 pixels are distributed at each of the gradation values.

For example, when image capturing a sixty-inch display with the pinhole camera having 4288×2848 pixels, one pixel is less than or equal to 30 μm in size. The captured image is not visible by definition of the human eyes.

Thus, by performing the above-described definition decreasing process, it is possible to evaluate the image based on the definition of the human eyes.

As a fourth step, the amount of variation of brightness of the image data, which corresponds to the interference pattern, is determined.

In the first embodiment, the speckle contrast value is determined based on the histogram, in which the occurrence frequency of the pixels of the obtained image data corresponding to the interference pattern is expressed at each gradation value.

Here, the speckle contrast value is a normalized value in which the standard deviation is normalized by the average value in the above-described histogram (e.g., the histogram shown in FIG. 21B).

That is, the speckle contrast value can be determined by the formula (1) as follows.

speckle contrast value=standard deviation/average value (1)

According to the scintillation evaluation method of the first embodiment, by capturing the image with the pinhole camera 10, the contrast of the interference pattern S which is image captured by the capturing element 14 increases. Therefore, a further distinct interference pattern is obtained.

As a result, a slight difference in scintillation is amplified, and the difference of the speckle contrast value is reflected depending on the amplified difference.

Also, by the spatial frequency filtering process, an intermittent component caused by a pixel grid or a black mask is removed.

In addition, an intermittent noise component with a greater period, such as brightness unevenness, is also removed.

Therefore, even if the type of display devices is varied, it is possible to extract only the spatial frequency component causing generation of a brindled pattern due to the interference from the image. Thereby, it is possible to equitably evaluate the scintillation without depending on the difference of pixel structure.

Furthermore, by using the equalizing process, human visual appreciation characteristics in a spatial axis direction are simulated, and it is possible to realize an evaluation in which a definition of the human eye is considered.

As a result, it is possible to obtain an evaluation result which coincides with human visual appreciation.

As described-above, according to the scintillation evaluation method of the first embodiment, it is possible to compare the slight differences of generated scintillation between various projectors. Also, it is possible to compare the slight differences between various modifications based on countermeasures in one projector.

Also, since the effects of background noise due to the pixel grid are reduced, it is possible to perform evaluation of scintillation with a high level of sensibility, reproducibility, and precision.

It is also possible to compare the differences in the speckle contrast values of various display devices by one-dimensional comparison, and set the target level to which scintillation must be reduced as a countermeasure.

In addition, since the evaluation result is reflected by the definition of the human eyes, consistency with a psychophysical value can be improved.

Also, by choosing as an evaluation device and a camera for general use and software for multiplicity of use, it is possible to obtain identical and low cost evaluation results even if a variety of people use the device, that is, even if there is a difference in user disposition.

Furthermore, in the it embodiment, optical processing is executed by the pinhole camera 10 in the first step and by software in the second and third steps. Thereby, it is possible to obtain an evaluation device having a very simple structure and multiplicity of purposes.

The reason it is possible to make the evaluation device, is that the above-described Fourier transform, Inverse-Fourier transform moving average filtering process (conversion of definition), and the like in the second and third steps are generally used and the software is commercially available. However it is difficult to improve the contrast (sensitivity) of the interference pattern by image processing compared with the two steps described above.

In the explanation described below, five modifications of the evaluation device are given as examples of single evaluation devices in the second to sixth embodiments.

### Second Embodiment

A second embodiment of the invention will be described below with reference to FIG. 22.

In the second embodiment, for example, a scintillation evaluation device for evaluating a transmission-type screen will be explained.

FIG. 22 is a schematic view showing a scintillation evaluation device of the second embodiment of the invention.

In FIG. 22, identical symbols are used for the elements which are identical to those of the first embodiment in FIGS. 1 to 3 are assigned identical symbols, and the explanations are omitted.

As shown in FIG. 22, a scintillation evaluation device 20 of the second embodiment includes a casing 21. The light source 2, the pinhole camera 10, and the data processing circuit 15 are disposed inside the casing 21.

A sample insertion opening 21a is formed on the top surface of the casing 21. A piece (sample 6a) of the transmission-type screen, which is a sample of an evaluation object, is inserted into the sample insertion opening 21a and disposed inside the casing 21.

The light source 2 is disposed so as to illuminate sample 6a with the light emitted from the light source 2.

The pinhole camera 10 is disposed at opposite to the light source 2 via the sample 6a.

The pinhole camera 10 can image capture the surface opposite to the light incidence surface of the sample 6a.

Furthermore, a display 22 is disposed on the top surface of the casing 21. The speckle contrast value which is the evaluation result is displayed on the display 22.

The capturing element included in the pinhole camera 10 captures the image data. The image data obtained by the pinhole camera 10 is sent to the data processing circuit 15. The image processing is performed on the image data and the speckle contrast value is determined as described in the first embodiment. The determined speckle contrast value is displayed on the display 22.

It is possible to evaluate the scintillation of a single transmission-type screen by using the scintillation evaluation device 20.

### Third Embodiment

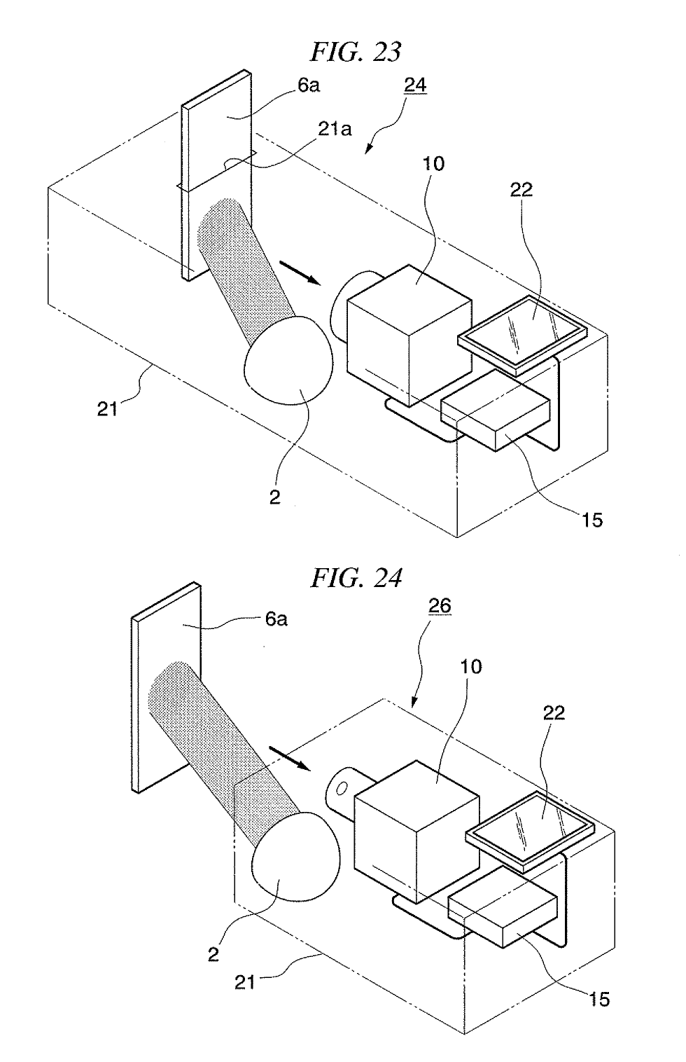

A third embodiment of the invention will be described below with reference to FIG. 23.

In the third embodiment, a scintillation evaluation device for evaluating a reflection-type screen will be explained as an example.

FIG. 23 is a schematic view showing a scintillation evaluation device of the third embodiment of the invention.

In FIG. 23, identical symbols are used for the elements which are identical to those of the second embodiment in FIG. 22 are assigned identical symbols, and the explanations are omitted.

As shown in FIG. 23, a scintillation evaluation device 24 of the third embodiment includes substantial identical constitution to the scintillation evaluation device 20 of the second embodiment.

However, in the third embodiment, the light source 2 and the pinhole camera 10 are disposed so as to face the identical surface of the sample 6a (sample to reflection-type screen). In other words, the light source 2 and the pinhole camera 10 are disposed on the identical surface side of the sample 6a. Thereby, the pinhole camera 10 can capture the image of the sample 6a from the light incident surface side.

This is the difference between the second embodiment and the third embodiment.

It is possible to evaluate the scintillation of a single reflection-type screen by using this scintillation evaluation device 24.

### Fourth Embodiment

A fourth embodiment of the invention will be described below with reference to FIG. 24.

The fourth embodiment is another example of a scintillation evaluation device for evaluating a reflection-type screen.

FIG. 24 is a schematic view showing a scintillation evaluation device of the fourth embodiment of the invention.

In FIG. 24, identical symbols are used for the elements which are identical to those of the above-described embodiments in FIGS. 22 and 23 are assigned identical symbols, and the explanations are omitted.

As shown in FIG. 24, the scintillation evaluation device 26 of the fourth embodiment includes substantial identical constitution to the scintillation evaluation device 24 of the third embodiment.

However, in the fourth embodiment, the light source 2 and the pinhole camera 10 are disposed so as to face to the exterior of casing 21. In this constitution, light is emitted from the light source 2 so as to emit toward the exterior of casing 21, and the pinhole camera 10 can capture the sample 6a which is disposed at the exterior of casing 21. Therefore, the pinhole camera 10 captures the sample 6a onto which the light emitted from the light source 2 is projected.

Therefore, it is possible to evaluate the scintillation of a reflection-type large-sized screen without special modification of the evaluation object and without using a sample of a screen similar to the third embodiment.

It is possible to evaluate the scintillation of the single reflection-type screen by using this scintillation evaluation device 26.

### Fifth Embodiment

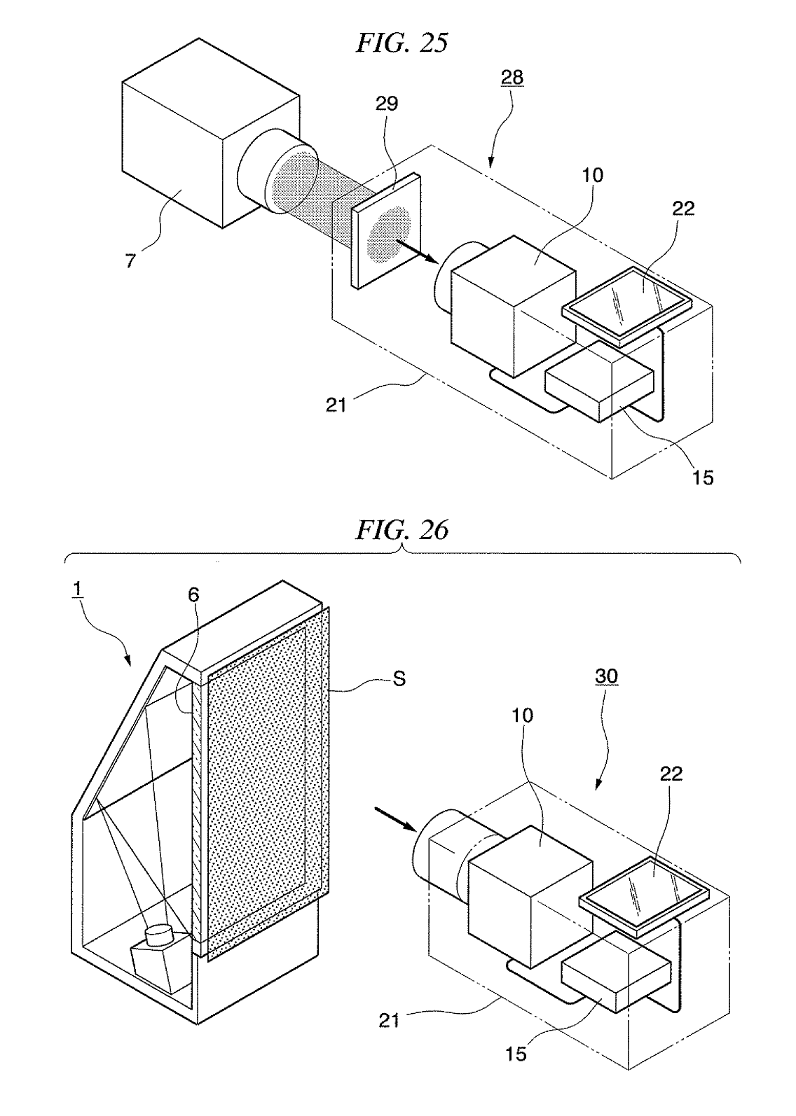

A fifth embodiment of the invention will be described below with reference to FIG. 25.

A scintillation evaluation device for evaluating a projection engine will be explained in the fifth embodiment for example.

FIG. 25 is a schematic view showing a scintillation evaluation device of the fifth embodiment of the invention.

In FIG. 25, identical symbols are used for the elements which are identical to those of the above-described embodiments in FIGS. 22 to 24 are assigned identical symbols, and the explanations are omitted.

As shown in FIG. 25, in the scintillation evaluation device 28 of the fifth embodiment, an opening is formed in a portion of the out side face of the casing 21, and a standard screen 29 is disposed in the opening. The outside ace of the casing 21 faces to the projection engine 7.

The pinhole camera 10 is disposed so as to capture the standard screen 29.

When the light emitted from an exterior projection engine 7 toward the standard screen 29, the pinhole camera 10 can capture a scintillation image.

It is preferable that the standard screen 29 be detachably disposed at the opening. In this case, it is possible to comprehend the compatibility of various screens and projection engines.

It is possible to perform the evaluation of projection engine by using this scintillation evaluation device 28. Also, in the development of a projection engine, for example, how the low coherent light is obtained can be evaluated.

### Sixth Embodiment

A sixth embodiment of the invention will be described below with reference to FIG. 26.

A scintillation evaluation device for evaluating various display devices including a rear projection-type projector will be explained in the fifth embodiment for example.

FIG. 26 is a schematic view showing a scintillation evaluation device of the sixth embodiment of the invention.

In FIG. 26, identical symbols are used for the elements which are identical to those of the above-described embodiments in FIGS. 22 to 25 are assigned identical symbols, and the explanations are omitted.

The scintillation evaluation device 30 of the sixth embodiment is different from the above-described embodiments, and the light source and the standard screen are unnecessary. It is sufficient that by only the pinhole camera 10, the data processing circuit is, and the display device 22 are provided.

When the pinhole camera 10 captures the sample (the display of the rear projection-type projector 1 in this embodiment), it is possible to evaluate the scintillation.

It is possible to comprehensively evaluate the scintillation of the entire display device including a display such as screen or the like by using this scintillation evaluation device 30.

The technical scope of this invention shall not be limited to the above embodiments. As a matter of course, the invention may include various modifications of the embodiment in a scope not deviating from the spirit of this invention.

In the above-described embodiments, the step for capturing the image by using the pinhole camera is adopted in order to increase the contrast of the interference pattern. For example, in order to increase the contrast of the interference pattern, a step for the image processing may be adopted.

Furthermore, the order to execute of the above-described steps shall not be limited to the above embodiments, and the order may be modified in various ways as needed.

Furthermore, as described above, it is sufficient that at least one of the above-described three problems is solved. Therefore, only steps for solving the problem may be adopted.

What is claimed is:

1. A scintillation evaluation method for quantitatively evaluating scintillation, the method comprising:
obtaining an image data that includes at least an interference pattern of scintillation;
increasing the contrast of the interference pattern; and
determining the amount of variation of brightness in the image data, the amount of the variation corresponding to the interference pattern whose contrast has been increased.

2. The evaluation method according to claim 1, wherein
the determining of the amount of variation of brightness includes:
creating a histogram based on the image data corresponding to the interference pattern whose contrast has been increased, the histogram expressing the occurrence frequency of pixels of the image data at each of the gradation values; and
determining the amount of variation of brightness by determining a speckle contrast value based on the histogram.

3. The evaluation method according to claim 1, wherein
the obtaining of the image data includes:
image capturing the scintillation by using a pinhole camera; and
capturing the image data including the interference pattern by image capturing the scintillation where the contrast of the interference pattern has been increased.

4. The evaluation method according to claim 1, further comprising:
removing a noise component corresponding to a pixel grid from the image data that includes the interference pattern.

5. The evaluation method according to claim 4, wherein
the noise component is removed by a spatial frequency filtering process using Fourier transform.

6. The evaluation method according to claim 1, further comprising:
decreasing the definition of the image data that includes the interference pattern.

7. The evaluation method according to claim 6, wherein
the definition is decreased by an equalizing process using a moving average filter.

8. A scintillation evaluation method for quantitatively evaluating scintillation, the method comprising:
obtaining an image data that includes at least an interference pattern of scintillation;
removing a noise component corresponding to a pixel grid from the image data that includes the interference pattern; and
determining the amount of variation of brightness in the image data, the amount of the variation corresponding to the interference pattern whose noise component has been removed.

9. The scintillation evaluation method according to claim 8, wherein
the determining of the amount of variation of brightness includes:
creating a histogram based on the image data corresponding to the interference pattern whose noise component has been removed, the histogram expressing the occurrence frequency of pixels of the image data at each of the gradation values; and
determining the amount of variation of brightness by determining a speckle contrast value based on the histogram.

10. The evaluation method according to claim 8, wherein
the noise component is removed by a spatial frequency filtering process using Fourier transform.

11. A scintillation evaluation method for quantitatively evaluating scintillation, the method comprising:
obtaining an image data that includes at least an interference pattern of scintillation;
decreasing the definition of the image data that includes the interference pattern; and
determining the amount of variation of brightness in the image data, the amount of variation corresponding to the interference pattern whose definition has been decreased.

12. The scintillation evaluation method according to claim 11, wherein
the determining of the amount of variation of brightness includes:
creating a histogram based on the image data corresponding to the interference pattern whose definition has been decreased, the histogram expressing the occurrence frequency of pixels of the image data at each of the gradation values; and
determining the amount of variation of brightness by determining a speckle contrast value based on the histogram.

13. The evaluation method according to claim 11, wherein
the definition is decreased by an equalizing process using a moving average filter.

14. A scintillation evaluation device for quantitatively evaluating scintillation, the device comprising:
a pinhole camera obtaining an image data that includes an interference pattern of scintillation;
an image processing section executing an image processing in which a noise component corresponding to a pixel grid is removed from the image data that includes the interference pattern, and in which the definition of the image data that includes the interference pattern is decreased; and
an operation section determining the amount of variation of brightness in the image data, the amount of the variation corresponding to the interference pattern whose noise component has been removed and whose definition has been decreased.

15. The scintillation evaluation device according to claim 14, wherein
the operation section creates a histogram based on the image data corresponding to the interference pattern whose noise component has been removed and whose definition has been decreased, the histogram expressing the occurrence frequency of pixels of the image data at each of the gradation values, and wherein
the operation section determines the amount of variation of brightness by determining a speckle contrast value based on the histogram.
